(19) United States
(12) Patent Application Publication
(10) Pub. No.: US 2023/0065244 A1
(43) Pub. Date: Mar. 2, 2023

(54) MEDICAL PREMATURE INFANT MANNEQUIN

(71) Applicant: San Jose State University Research Foundation, San Jose, CA (US)

(72) Inventor: Arlene Spilker, San Jose, CA (US)

(21) Appl. No.: 17/929,156

(22) Filed: Sep. 1, 2022

Related U.S. Application Data
(60) Provisional application No. 63/239,778, filed on Sep. 1, 2021.

(51) Int. Cl. G09B 23/32

(52) U.S. Cl. CPC G09B 23/32

(57) ABSTRACT

Various embodiments disclosed relate to a premature infant mannequin with realistic movements. The present disclosure includes a premature infant mannequin with joints that simulate realistic movements, and methods of training neonatal staff with the premature infant mannequin.

### CROSS-REFERENCE TO RELATED APPLICATION

This patent application claims the benefit of U.S. Provisional Patent Application No. 63/239,778, filed Sep. 1, 2021, entitled “MEDICAL PREMATURE INFANT MANNEQUIN”, which is incorporated by reference herein in its entirety.

### BACKGROUND

Approximately 10% of infants in 2019 were born prematurely. These preterm infants were sent to the Neonatal Intensive Care Unit (NICU) immediately after birth as a result of not fully developing. Many of these preterm infants suffer from hypotonia due to not fully developing their musculoskeletal system. A consequence of infants suffering from hypotonia is that they are not able to support themselves, including positioning their bodies. To treat infants with hypotonia, NICU nurses perform developmental positioning on them.

### SUMMARY OF THE DISCLOSURE

The present disclosure provides a realistic premature infant positioning mannequin that is primarily intended for the education and training of neonatal intensive care unit (NICU) nurses, doctors, and other NICU staff. This mannequin can be the size of an infant born at 26 weeks gestation, such as about 1 pound 11 ounces and 13 inches long, and can have appropriate proportions and flexibility that mimics a preterm infant. Proper developmental positioning is an important skill for NICU nurses and the disclosure techniques, methods, and mannequins can allow them to practice and improve their skills in this area.

In the U.S. ten percent of all babies are born prematurely (less than 37 weeks gestation) and the rate of preterm birth has not significantly changed in the last twenty years. The cost of caring for these babies exceeds $26 billion per year. Premature infants are at high risk for multiple negative physiologic, developmental, and physical abnormalities because of their premature birth. There are multiple short and long term complications to preterm birth including poor weight gain, respiratory compromise, neurological complications, musculoskeletal deformities, and neurodevelopmental disabilities.

Proper developmental positioning (a.k.a. neuroprotective positioning) can be effective in preventing both short and long term complications. Because infants are unable to position themselves, they rely on nurses to provide them with the proper support and boundaries to maximize their growth and minimize negative outcomes. Some of these outcomes include: increased oxygen needs, decreased weight gain, sleep disturbances, and musculoskeletal deformities such as plagiocephaly (flat spots on their heads), torticollis (shortened neck muscles leading to inability to turn head both directions) and shoulder retraction. These negative outcomes increase the hospital length of stay for these infants, and often require them to have additional interventions such as physical, occupational, or helmet therapy. All of the negative outcomes increase health care costs and cause significant distress for the infants and their families.

Properly positioning infants is universally recognized as an evidence-based practice that should be the standard of care for all patients being cared for in a NICU. However, according to multiple research studies, NICU nurses continue to struggle with this basic skill. Although there are multiple commercially made developmental positioning aids available on the market, currently there is no premature infant positioning mannequin for training purposes available. NICU nurses are not currently training with an accurate infant model before performing developmental positioning on premature infants. With a uniform and practical model of a premature infant, nurses will become more proficient in developmental positioning before using the treatment in person. The model will help by being used as hands-on training that is paired with the Infant Positioning Assessment Tool (IPAT). The goals of the Infant Positioning Tool are to educate NICU nurses about proper positioning and to provide an evaluation method to ensure their competence. We anticipate that the product will also promote this treatment to be more universally used.

Developmentally positioning preterm infants can provide them with an optimal environment for growth and can help prevent long term complications. However, neonatal nurses need proper training materials in order to learn how to developmentally position their patients. A realistic mannequin that is able to be manipulated and positioned in a developmentally appropriate way does not currently exist. Proper developmental positioning is an essential skill for NICU nurses and the evidence shows that nurses need more training and resources to meet the developmental positioning needs of their patients. This mannequin will allow them to practice and improve their developmental positioning skills using a mannequin instead of practicing this skill with their patients, which is the current practice. This is a low cost solution which has the potential to prevent very costly problems.

An example mannequin discussed herein is the size of an infant born at 26 weeks gestation. For example, the mannequin can weigh approximately 1 pound 11 ounces and be 13 inches long, and have appropriate proportions and flexibility that mimics a preterm infant. It can have the appropriate range of motion in all extremities and it can be able to be developmentally positioned in supine, prone, and sidelying positions. This mannequin can help nurses practice or perfect a skill they implement every day in practice with every patient they encounter.

This mannequin can be used for education and training purposes for neonatal intensive care unit nurses. Additionally, it can be scaled up to mimic a full term newborn infant and be used for educating expectant parents about how to safely and properly handle an infant.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a premature infant mannequin in an example.

FIGS. 2A-2B illustrate a premature infant mannequin in an example.

FIGS. 3A-3C illustrate a premature infant mannequin in various positions, in an example.

### DETAILED DESCRIPTION

Discussed herein are methods and devices including a realistic, premature infant mannequin. The mannequin can be proportioned, for example, based on an average 26-week premature infant. The limbs of the mannequin can be attached to the torso with joints that simulate actual neonatal movement, such that a NICU nurse or other professional in training can practice holding and working with the premature infant in a skills lab.

Preterm infants are a particularly vulnerable population who require technologically advanced medical interventions, and highly specialized nursing care in order to survive and thrive. In the United States (U.S.), preterm birth impacts about 500,000 infants every year, is the leading cause of long-term neurodevelopmental disability, and has an estimated cost of $26 billion dollars per year (Preterm Birth, n.d.). This problem is not limited to the United States; the World Health Organization estimates that preterm birth affects somewhere between 5% and 18% of the infants born in 184 countries, or about 15 million preterm births every year (see Preterm Birth: Fact Sheet Number 363, 2013).

Infants born at less than 37 weeks gestation are considered preterm. This premature birth interrupts their intrauterine growth and development, and exposes them to an environment that is completely different from the womb. Their immature organs are not prepared for the “normal” newborn care environment of swaddling, breastfeeding and being held by their family for hours at a time (Symington and Pinelli, 2006). Extremely preterm (<28 weeks) and moderately preterm (28-32 weeks) infants frequently require complex and highly technical interventions for survival, and their caregivers must have advanced knowledge and skills to ensure these infants survive even though they may be at the edge of viability (Louw and Maree, 2005).

The tremendous physical, emotional and economic implications of prematurity (and the associated potential long-term negative effects) make it a significant worldwide problem (Preterm Birth: Fact Sheet Number 363, 2013). Additionally, the lack of significant progress in the prevention of preterm births leads one to believe that more focus should be aimed at decreasing the negative sequelae of preterm birth. Thus, more research is needed on maximizing the proper growth and development of premature infants, particularly in the area of improving neurodevelopmental outcomes (Louw and Maree, 2005; VandenBerg, 2007).

In order to improve the developmental proficiency of neonatal intensive care unit nurses and staff, a standardized infant positioning assessment tool (hereinafter “IPAT”) and a bedside education program were introduced to the registered nurses in bed level III neonatal intensive care units in the western United States. A developmental positioning team collected pre-intervention positioning scores on preterm infants. This was followed by a survey of the registered nurses' beliefs and attitudes, the introduction of the standardized assessment tool and an informal education program. Post-intervention positioning scores were collected on preterm infants, and analysis of the data indicated there was a statistically significant change in mean positioning scores. Additionally, the registered nurses identified several barriers to the implementation of developmental positioning. This research indicates the use of a standardized infant positioning assessment tool and bedside education may be useful strategies for improving the developmental positioning proficiency of NICU nurses.

The study allowed for implementing a standardized positioning assessment tool may improve the developmental positioning proficiency of NICU nurses, informal bedside education may be an effective strategy to educate registered nurses, and improving developmental positioning remains a goal for practice.

There is a need to improve developmental positioning of NICU patients; researchers in several countries have developed standardized tools to assess positioning The IPAT is an available tool that has been determined to be valid and reliable, but there have been limited published research studies that used the IPAT as part of the research, and the standardized definition of developmental positioning remains undetermined.

Methods and Objectives

The objective of this study was to determine if the use of a standardized infant positioning assessment tool (the IPAT) and informal bedside education is an effective way to improve the developmental positioning proficiency of NICU nurses.

Setting

This was a quasi-experimental, pre-test post-test intervention implemented in a 46 bed, level III NICU in the western United States. The average daily census for the NICU during the research was approximately 35 patients. The education provided on developmental positioning for this unit has been scant, with the only formal education piece being a skills lab approximately ten years ago. Newly hired registered nurses receive research articles about developmental care, but no other information or training about developmental positioning is provided. The NICU generally has a wide variety of commercially manufactured developmental positioning products available, but at the time of this research, the gel filled pillows (used for postural support of the infant) were unavailable and linen rolls were being substituted for those commercial products.

Ethical Approval

This research was approved by the Institutional Review Boards (IRBs) of the hospital where the intervention took place, and Fresno State University in the United States. Permission to use the IPAT tool for this research was obtained from a representative of Philips Healthcare. An introductory letter outlining the participants' rights accompanied the NICU nurse survey, and to prevent bias, the survey was voluntary and all data were aggregated before analysis. The registered nurses were reminded throughout the study that the IPAT data being collected on their patients was for informational and educational purposes only. Scores were not being reported to hospital administration, and there was no punitive aspect associated with achieving a low score on the IPAT. The IPAT measurements did not contain any identifiable information about the infant being scored, other than corrected gestational age, and a notation of any condition or equipment that may interfere with optimal developmental positioning. Again, all data were aggregated before analysis. Additionally, registered nurses providing the care at the time of scoring were not identified on the IPAT forms.

Participants

During the time of the research the number of active nurses was approximately 80. A team of eight nurses (and the primary researcher) was selected from the NICU staff to be members of the developmental positioning team. These nurses were from all three shifts, had demonstrated both proficiency in developmental positioning, and an interest in improving the consistency of infant's positioning in the NICU. These team members collected IPAT scores pre and post-intervention and acted as resources to the staff in the NICU.

Data Collection

After determining inter-rater reliability (IRR), the developmental positioning team collected IPAT scores for infants in the NICU. Scores were collected on infants who were <34 weeks gestation, in incubators, and using developmental positioning supplies (Snuggle-Up, Bendy Bumper, linen rolls, etc.). The Registered Nurses (RNs) regularly used developmental positioning supplies for all non-swaddled infants in incubators, but the way they were used was quite variable. Swaddled infants in incubators or open cribs were not scored. After these scores were obtained, a survey was distributed to the NICU nurses and the intervention phase began. The survey consisted of demographic data and a few questions about developmental positioning knowledge and beliefs. The intervention consisted of introduction of the IPAT tool and several types of educational materials in multiple formats. These materials were individualized for this particular NICU; they were viewable in less than 30 minutes (from work or home) and emphasis was placed on providing postural support using linen and blanket rolls until the gel pillows become available again. The materials consisted of an IPAT at every bedside, a narrated slide presentation that was available on YouTube, copies of the slides and information in each of the NICU open bay rooms, and the break room, and a set of slides on each of the bedside computers in the NICU.

During the month long intervention phase, the nurses were encouraged to take the survey, to review the materials (particularly the IPAT), and to use the developmental positioning team members as resources. After one month, 55 IPAT scores were collected on infants who were <34 weeks gestation, in incubators, and using developmental care supplies (Snuggle-Up, Bendy Bumper, etc.). Swaddled infants and infants in open cribs were not scored.

The IPAT tool and a brief survey developed by the primary researcher were used for this project. The survey developed by the primary researcher contained demographic questions and five open-ended questions regarding developmental care knowledge and beliefs.

The pre-intervention IPAT scores were collected over a period of 12 days, just prior to the beginning of the intervention. The post-intervention IPAT scores were collected over a period of eight days, just after the completion of the intervention. The NICU nurses survey was available (in both paper and electronic versions) to the NICU nurses during the entire month of the intervention.

Data Analysis

Inter-rater reliability (IRR) was obtained from the developmental positioning team by having each member independently determine IPAT scores for five “sample” infants, and then computing intraclass correlations for both consistency and absolute agreement. The pre-intervention and post-intervention IPAT scores were analyzed using a two-sample t-test because the infants scored before the intervention was not the same infants tested after the intervention. Levene's test was used to test for homogeneity of variances prior to the t-test. Demographic data and open-ended questions on the NICU nurses survey were collected for descriptive analysis.

Results

Interrater reliability testing for the IPAT was completed for the nine raters: the IRR intraclass correlation for consistency of single measures was 0.797 and for consistency or average measures was 0.972. The IRR intraclass correlation for absolute agreement of single measures was 0.712 and for absolute agreement of average measures was 0.957. Cronbach's alpha was also calculated (0.972) and indicated that the IPAT had internal consistency.

There were 54 pre-intervention scores and 55 post-intervention scores collected for two different samples of infants. Levene's test indicated that the assumption of equal variances was met (F=1.546, p=0.217). The independent samples t-test indicated a statistically significant (t=−2.246, df=107, sig=0.027) increase in the mean IPAT scores of the two groups. The mean IPAT score for the pre-intervention group was 8.39 (standard deviation=2.498) and the mean IPAT score of the post-intervention group was 9.42 (standard deviation=2.283).

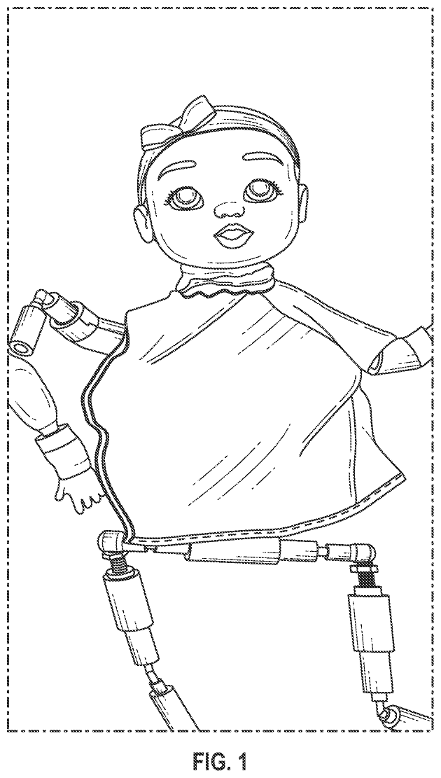

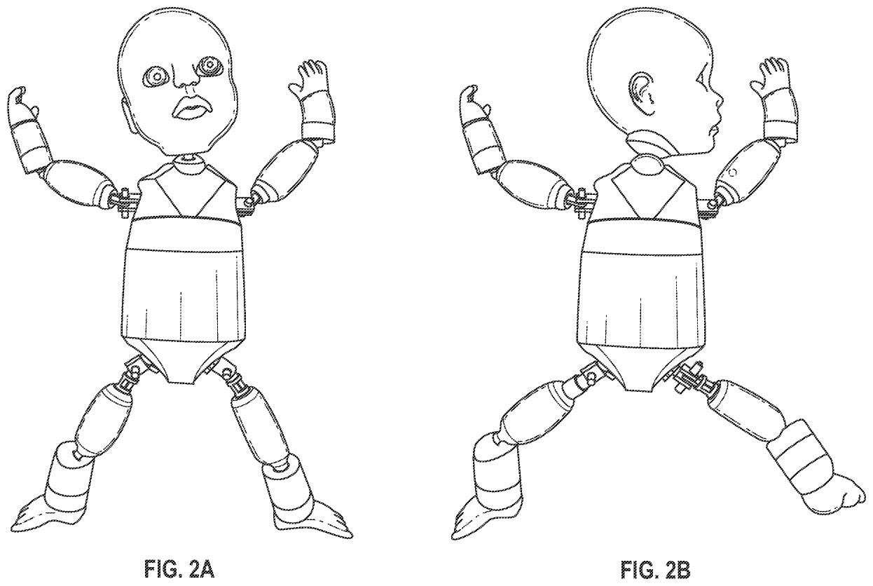

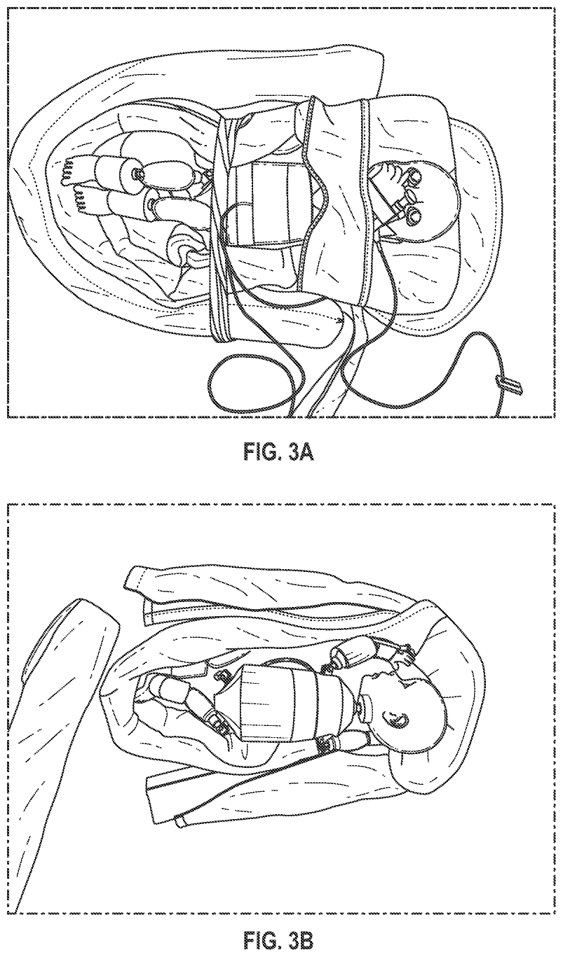

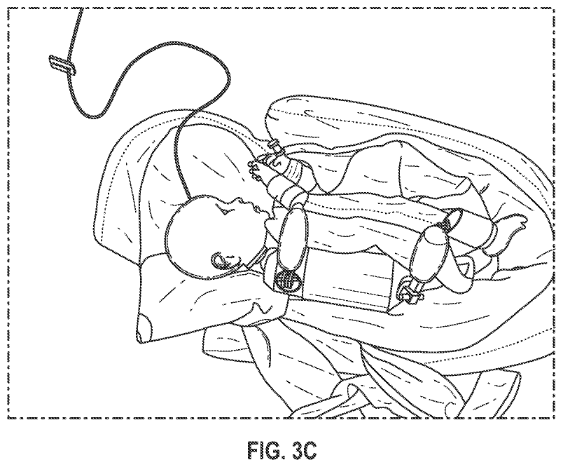

The means for each element of the IPAT score (shoulders, hands, hips, knees/ankles/feet, head and neck) were also compared pre and post-intervention. The mean score for shoulder placement was 1.3 (standard deviation=0.69) pre-intervention and 1.6 (standard deviation=0.63) post-intervention. The mean score for hand placement rose from 1.2 (standard deviation=0.81) pre-intervention to 1.5 (standard deviation=0.69) post-intervention. Mean hip placement scores pre-intervention were 1.7 (standard deviation=0.58) and 1.9 (standard deviation=0.37) post-intervention. Mean scores for the positioning of knees, ankles and feet were 1.7 (standard deviation=0.61) pre-intervention and 1.9 (standard deviation=0.26) post-intervention. The mean score for head placement decreased from 1.1 (standard deviation=0.78) pre-intervention to 1.0 (standard deviation=0.84). The mean score for neck positioning was 1.5 (standard deviation=0.57) pre-intervention and 1.6 (standard deviation=0.57) post-intervention (FIG. 1).

The NICU nurses survey had a 50% response rate (n=41). The respondents were all female; they were primarily Caucasian (80%) and Asian or Pacific Islander (13%), and most were educated at a baccalaureate level or higher (85%). When asked “How often do you use developmental positioning techniques in the NICU?” the respondents indicated that they “Always” (76%) or “Usually” (22%) used them, with one respondent (2%) indicating they “Sometimes” used developmental positioning techniques.

Responses to the open-ended query “Where/how/from whom did you learn about developmental positioning?” indicated that most nurses (42%) learned from other registered nurses in the unit, and from the one skills lab mentioned previously (19%). Other sources of developmental positioning education included conferences (12%), books/articles (12%), other hospitals (10%) and sales representatives (5%).

Responses to the prompt “Identify any barriers to implementing developmental positioning.” indicated that the largest barriers were the lack of positioning supplies (32%) and the lack of positioning education (27%). Other barriers identified were patient factors such as medically necessary tubes and lines (24%), nursing compliance (8%), staffing issues and time constraints (6%) and parental perceptions (3%).

### Discussion

Improving the developmental positioning proficiency of NICU nurses was a primary aim of this study. Results from this study indicate that the IPAT tool and informal access to education materials may be effective in improving the developmental positioning proficiency of NICU nurses. Although the increase in mean IPAT scores was statistically significant, the improvement was small and the post-intervention scores still did not reach the recommended level of 10-12 points. Additionally, the scores were obtained on different infants, while being cared for by different nurses, which may have affected the outcomes. It is unknown whether the scores increased because of the introduction of the tool, or because of the informal education.

Significant barriers to providing developmental positioning were identified: shortage of positioning supplies, lack of education and patient factors. Some of these factors could possibly be eliminated as barriers, if the appropriate education and training were provided to the registered nurses. These findings are consistent with the limited evidence that was found in the literature review. This research indicates that implementing a tool for standardizing positioning, and/or providing education to registered nurses may increase their developmental positioning proficiency.

Limitations for this study include the short intervention time and the lack of availability of some developmental positioning supplies. The acuity of the infants may have differed pre-intervention and post-intervention which could have impacted the change in IPAT scores. Additionally, it is unknown how many nurses reviewed the provided educational materials, or if their attitudes or knowledge changed as a result of the intervention. This improvement in positioning may be temporary, and it is unknown if it will be sustained.

Conclusion

Registered nurses require the appropriate tools and necessary education to provide patient care that is evidence-based and improves outcomes. This research indicates that a standardized positioning tool and bedside education are potential strategies to improve developmental positioning proficiency. This project did not require significant funding in order to achieve a small change in practice, and it could be tailored to the individual needs of any NICU. Developmental positioning continues to be inconsistently applied, and effective ways to improve the proficiency of NICU nurses in this area are still needed.

### Various Notes & Examples

Example 1 can include a neonatal mannequin comprising: a neonatal body comprising a torso, a head, and four limbs, arranged and connected to model a premature infant, wherein each of the head and the four limbs are moveable attached to the torso by a respective joint, the joints allowing simulation of realistic neonatal movement of the head and the limbs relative the torso, wherein the torso, the head, and the four limbs are proportioned to simulate an average premature infant body.

Example 2 can include Example 1, wherein each of the joints is configured to move in a direction natural to a premature infant.

Example 3 can include any of Examples 1-2, wherein each of the joints is configured to move at an angle natural to a premature infant.

Example 4 can include any of Examples 1-3, further comprising one or more sensors configured to monitor the movement of each of the joints.

Example 5 can include a neonatal mannequin comprising: a torso, the torso being anatomically correct for a neonatal infant, the torso having a first side, a second side, an upper portion and a lower portion; a first arm attached to the torso at the first side in the upper portion, the first arm attached to the torso by a first joint configured to simulate premature infant movement; a second arm attached the torso at the second side in the upper portion, the second arm attached to the torso by a second joint configured to simulate premature infant movement; a first leg attached to the torso at the first side in the lower portion, the first leg attached to the torso by a third joint configured to simulate premature infant movement; a second leg attached to the torso at the second side in the lower portion, the second leg attached to the torso by a fourth joint configured to simulate premature infant movement; and a head connected to the torso by a neck at an end of the upper portion, the neck comprising a neck joint, wherein the neck joint is configured to simulate premature infant movement, wherein each of the first arm, second arm, first leg, second leg, and head are moveable relative the torso in a realistic manner for a neonatal infant, and each of the first arm, second arm, first leg, second leg, and head are proportioned relative the torso to simulate a premature infant.

Example 6 can include Example 5, wherein the first, second, third, and fourth joints comprise ball and socket joints.

Example 7 can include any of Examples 5-6, wherein the first and second joints comprise compound joints configured to simulate a neonatal infant shoulder.

Example 8 can include any of Examples 5-7, wherein the third and fourth joints comprise compound joints configured to simulate a neonatal infant hip.

Example 9 can include any of Examples 5-8, wherein the neck joint comprises a plurality of facet joints.

Example 10 can include a method of training medical professionals for neonatal intensive care, the method comprising: practicing handling a premature infant by moving a premature infant mannequin between different positions, the premature infant mannequin comprising four limbs configured to simulate realistic body movement.

Example 11 can include Example 10, wherein the different positions comprise supine, prone, and sidelying position.

Example 12 can include any of Examples 10-11, further comprising moving one or more joints on the premature mannequin within a predetermined range of motion.

Example 13 can include any of Examples 10-12, wherein, if moving the one or more joints extends outside of the predetermined range of motion, an alert is given.

Example 14 can include any of Examples 10-13, wherein the one or more joints are configured to prevent motion outside the predetermined range of motion.

Example 15 can include any of Examples 10-14, further comprising positioning the head and neck of the mannequin within a predetermined range of motion.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A neonatal mannequin comprising:
a neonatal body comprising a torso, a head, and four limbs, arranged and connected to model a premature infant,
wherein each of the head and the four limbs are moveable attached to the torso by a respective joint, the joints allowing simulation of realistic neonatal movement of the head and the limbs relative the torso,
wherein the torso, the head, and the four limbs are proportioned to simulate an average premature infant body.

2. The mannequin of claim 1, wherein each of the joints is configured to move in a direction natural to a premature infant.

3. The mannequin of claim 1, wherein each of the joints is configured to move at an angle natural to a premature infant.

4. The mannequin of claim 1, further comprising one or more sensors configured to monitor the movement of each of the joints.

5. A neonatal mannequin comprising:
a torso, the torso being anatomically correct for a neonatal infant, the torso having a first side, a second side, an upper portion and a lower portion;
a first arm attached to the torso at the first side in the upper portion, the first arm attached to the torso by a first joint configured to simulate premature infant movement;
a second arm attached the torso at the second side in the upper portion, the second arm attached to the torso by a second joint configured to simulate premature infant movement;
a first leg attached to the torso at the first side in the lower portion, the first leg attached to the torso by a third joint configured to simulate premature infant movement;
a second leg attached to the torso at the second side in the lower portion, the second leg attached to the torso by a fourth joint configured to simulate premature infant movement; and
a head connected to the torso by a neck at an end of the upper portion, the neck comprising a neck joint, wherein the neck joint is configured to simulate premature infant movement,
wherein each of the first arm, second arm, first leg, second leg, and head are moveable relative the torso in a realistic manner for a neonatal infant, and each of the first arm, second arm, first leg, second leg, and head are proportioned relative the torso to simulate a premature infant.

6. The mannequin of claim 5, wherein the first, second, third, and fourth joints comprise ball and socket joints.

7. The mannequin of claim 5, wherein the first and second joints comprise compound joints configured to simulate a neonatal infant shoulder.

8. The mannequin of claim 5, wherein the third and fourth joints comprise compound joints configured to simulate a neonatal infant hip.

9. The mannequin of claim 5, wherein the neck joint comprises a plurality of facet joints.

10. The mannequin of claim 1, further comprising two ankle joints connecting the first and second legs to first and second feet.

11. The mannequin of claim 1, further comprising two wrist joints connects the first and second arms to first and second hands.

12. A method of training medical professionals for neonatal intensive care, the method comprising:
practicing handling a premature infant by moving a premature infant mannequin between different positions, the premature infant mannequin comprising four limbs configured to simulate realistic body movement.

13. The method of claim 12, wherein the different positions comprise supine, prone, and sidelying position.

14. The method of claim 12, further comprising moving one or more joints on the premature mannequin within a predetermined range of motion.

15. The method of claim 14, wherein, if moving the one or more joints extends outside of the predetermined range of motion, an alert is given.

16. The method of claim 14, wherein the one or more joints are configured to prevent motion outside the predetermined range of motion.

17. The method of claim 12, further comprising positioning the head and neck of the mannequin within a predetermined range of motion.
